(19) United States
(12) Patent Application Publication
(10) Pub. No.: US 2025/0384312 A1
(43) Pub. Date: Dec. 18, 2025

(54) DISTRIBUTED INFERENCE ENGINE

(71) Applicant: Apple Inc., Cupertino, CA (US)

(72) Inventor: Kulin SETH, San Jose, CA (US)

(21) Appl. No.: 19/182,196

(22) Filed: Apr. 17, 2025

Related U.S. Application Data
(60) Provisional application No. 63/657,716, filed on Jun. 7, 2024.

(51) Int. Cl. G06N 5/043

(52) U.S. Cl. CPC G06N 5/043

(57) ABSTRACT

A distributed inference engine system that includes multiple inference engines is disclosed. A particular inference engine of the multiple inference engines may receive a prompt and its associated data, and divide the data into multiple data portions that are distributed to the multiple inference engines. Operating in parallel, and using a machine-learning model and respective data portions, the multiple inference engines generate an initial token. The multiple inference engines also generate, in parallel and using corresponding portions of the machine-learning model and the initial token, a subsequent token.

### CROSS-REFERENCE TO RELATED APPLICATIONS

The present application claims the benefit of U.S. Provisional Application No. 63/657,716, entitled “DISTRIBUTED INFERENCE ENGINE,” filed Jun. 7, 2024, the content of which is incorporated by reference herein in its entirety for all purposes.

### FIELD

The described embodiments relate generally to artificial intelligence and, more particularly, to distributed inference engine systems.

### BACKGROUND

Artificial intelligence (or “AI”) is widely used in industry, government and science. In general, AI refers to computer systems that mimic human intelligence and problem solving capabilities to accomplish advance tasks. Such computer systems may employ machine learning using training data sets to improve their performance at particular tasks.

AI systems have a wide range of applications. For example, AI systems can be used as part of advanced web search engines and recommendation engines for making purchases, selecting movies to watch, and the like. Additionally. AI systems can be used to allow a computer to interact with a user via human speech, or to generate/create text, images, sounds, etc. AI systems can also be used as part of autonomous vehicle systems.

### SUMMARY

Various embodiments of a distributed inference engine system are disclosed. Broadly speaking, the distributed inference engine system can include a leader inference engine and a plurality of follower inference engines. The leader inference engine may be configured to receive a prompt that includes prompt data, and divide the prompt data into a plurality of data portions. The leader inference engine may be further configured to send respective data portions to the plurality of follower inference engines. The plurality of follower inference engines, along with the leader inference engine, may be configured to generate, in parallel using respective copies of a machine-learning model and the respective data portions, an initial token, and to generate, in parallel using corresponding model portions of the machine-learning model and the initial token, a subsequent token.

In other embodiments, the plurality of follower inference engines, along with the leader inference engine, may be configured, in response to a detection of a boot operation, to load respective copies of the machine-learning model, and assign the corresponding portions of the machine-learning model to the leader inference engine and the plurality of follower inference engines.

### BRIEF DESCRIPTION OF THE DRAWINGS

FIG. 1 is a block diagram depicting an embodiment of a distributed inference engine system.

FIG. 2 is a block diagram depicting initialization of a distributed inference engine system during a boot operation.

FIG. 3 is a block diagram depicting an embodiment of a leader inference engine.

FIG. 4 is a block diagram depicting an embodiment of a follower inference engine.

FIG. 5 is a block diagram depicting an embodiment of user equipment connecting to a server that includes a distributed inference engine system.

FIG. 6 is a flow diagram depicting an embodiment of a method for operating a distributed inference engine system.

FIG. 7 is a flow diagram depicting an embodiment of a method for initializing a distributed inference engine system.

### DETAILED DESCRIPTION

AI computer systems can perform a variety of tasks such as controlling autonomous vehicles or generating text or images based on a prompt. Such AI computer systems can employ machine learning or deep learning algorithms that use neural network hardware to “learn” from large amounts of data. Various combinations of hardware and software can be used to implement such AI computer systems.

One technique for implementing an AI computer system is the use of inference engines that apply a machine-learning model to a dataset in order to generate an output or prediction. For example, in response to receiving a prompt, an inference engine can apply the machine-learning model to generate a numerical score, a string of text, an image, or any other suitable type of data. As used herein, an inference engine refers to one or more pieces or modules of software executing on a processor or other suitable circuit to implement a machine-learning inference algorithm.

A machine-learning model refers to a collection of data that has been trained to recognize certain types of patterns. Such a model can include multiple weights that determine strengths between successive neurons in a neural network. During a training phase, the machine-learning model is developed and trained by running the inference algorithm on example data. Based on results of such training runs, the weights can be modified or adjusted to improve the pattern recognition of the machine-learning model.

As AI has continued to evolve, larger and larger data sets and machine-learning models are being employed. The use of large data sets and models can, however, result in latency and runtime issues. To remediate some of the problems, some AI computer systems employ various types of parallelism to spread or distribute processing across multiple inference engines. For example, some AI computer systems employ data parallelism in which different portions (or “shards”) of input data are processed by different inference engines. Other AI computer systems employ pipeline or tensor parallelism where different parts of a model are processed by different inference engines.

Even with the use of parallelism, there may still be latency issues within a distributed inference engine AI computer system. For example, in AI computer systems that employ data parallelism, the initial processing of input data may be efficient, but after initial tokens are generated, the computer system may become less efficient as the processing becomes more bandwidth constrained due to the communication needed between the various inference engines.

The embodiments illustrated in the drawings and described below may provide techniques for implicitly switching between data parallelism and tensor parallelism in an AI computer system during the processing of a prompt. By implicitly switching from data parallelism to tensor parallelism, the AI computer system can use data parallelism during the initial compute constrained portion of the processing, and rely on tensor parallelism during the subsequent bandwidth constrained portion of processing, thereby reducing latency and managing power consumption.

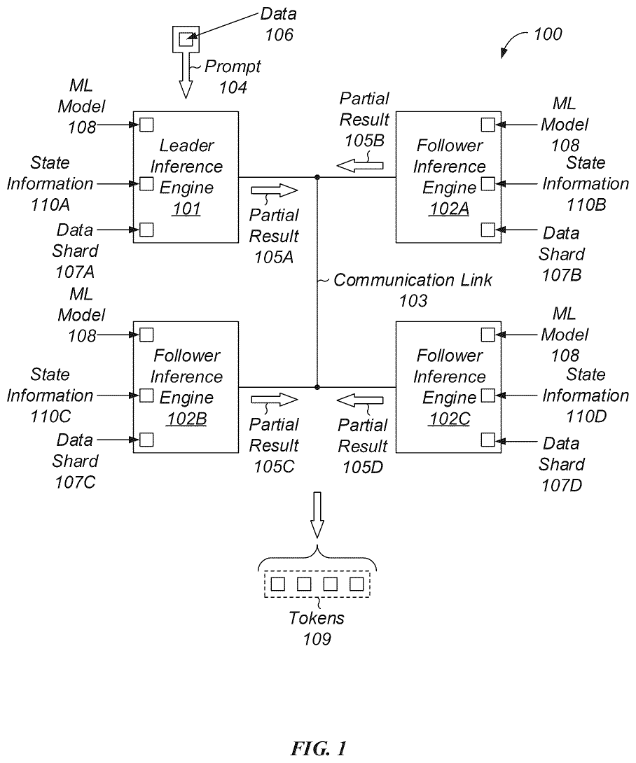

A block diagram of a distributed inference engine system is depicted in FIG. 1. As illustrated, distributed inference engine system 100 includes leader inference engine 101 and follower inference engines 102A-C coupled together via communication link 103. Although only three follower inference engines are depicted in the embodiment of FIG. 1, in other embodiments, any suitable number of follower inference engines may be employed.

Leader inference engine 101 is configured to receive prompt 104, which includes data 106. As used herein, a prompt refers to an input to an AI system that can include a question, a request, a topic posed by a user, or any other suitable query. As described below, prompt 104 may be generated on user equipment that is configured to send the prompt to distributed inference engine 100.

As noted above, the initial stage of processing data 106 can be compute constrained. As such, data parallelism can be employed to allow each of leader inference engine 101 and follower inference engines 102A-102C to work on different portions or shards of data 106. In preparation for employing data parallelism, leader inference engine 101 is further configured to divide data 106 into a plurality of portions or shards, i.e., data shards 107A-107D.

In various embodiments, leader inference engine 101 may divide data 106 into a number of portions that corresponds to a total number of inference engines included in distributed inference engine system 100. Alternatively, or additionally, leader inference engine 101 may divide data 106 based on a desired power consumption. It is noted that, in some embodiments, the respective sizes of data shards 107A-107D may not be the same allowing for an asymmetrical distribution of data 106 across leader inference engine 101 and follower inference engines 102A-102C.

Leader inference engine 101 is also configured to send data shards 107B-107D to follower inference engines 102A-102C, while reserving data shard 107A for itself. In various embodiments, leader inference engine 101 may send data shards 107B-107D to follower inference engines 102A-102C via communication link 103. In some cases, leader inference engine 101 may store data shards 107B-107D in predetermined address locations in respective memory circuits included in follower inference engines 102A-102C. In some cases, leader inference engine 101 may be configured to encrypt data shards 107B-107D before they are transmitted over communication link 103. Such encryption can, in various embodiments, increase security of communication between leader inference engine 101 and follower inference engines 102A-102C.

As noted above, when distributed inference engine system 100 is initially consuming a large amount of data upon receiving a prompt, operating in data parallelism mode can improve performance while processing the input data. To accomplish this, leader inference engine 101 and follower inference engines 102A-102C are configured to generate, in parallel using respective copies of a machine-learning model (denoted as “ML model 108”) and respective data shards 107A-107D, an initial token of tokens 109. As used herein, a token refers to a portion or a piece of data such as a word, image patch, partial sentence, and the like.

Once at least one initial token of tokens 109 has been generated, distributed inference engine system 100 may be further configured to switch to tensor parallelism. To accomplish this, leader inference engine 101 and follower inference engines 102A-102C are configured to generate, in parallel using corresponding portions of ML model 108 and the initial token of tokens 109, a subsequent token of tokens 109. In various embodiments, leader inference engine 101 and follower inference engines 102A-102C may be further configured to generate additional tokens while operating in tensor parallelism mode until a final outcome or prediction is achieved.

In some embodiments, leader inference engine 101 and follower inference engines 102A-102C may exchange state information 110A-110D as part of the switch from data parallelism to tensor parallelism. In various embodiments, state information 110A-110D may be encrypted prior to the exchange.

At various points during the processing of prompt 104, a given one of leader inference engine 101 and follower inference engines 102A-102C may need a partial result from another one of the inference engines. To allow for this, a synchronization or “all gather” command can be issued by leader inference engine 101. In response to the all gather command, partial results 105A-105D are made available to the other inference engines. In some embodiments, partial results 105A-105D may be sent from one inference engine to another. Alternatively, partial results 105A-105D may be placed in corresponding buffers from which the inference engines may retrieve partial results 105A-105D. In other embodiments, leader inference engine 101 and follower inference engines 102A-102C may be configured to encrypt corresponding ones of partial results 105A-105D prior to transfer.

It is noted that while the embodiment of FIG. 1 describes dynamically switching between data parallelism and tensor parallelism, in other embodiments, distributed inference engine system 100 may switch between other types of parallelism, e.g., pipeline parallelism, to reduce latency and/or power consumption. In some cases, distributed inference engine system 100 may be further configured to dynamically switch multiple times between two or more types of parallelism.

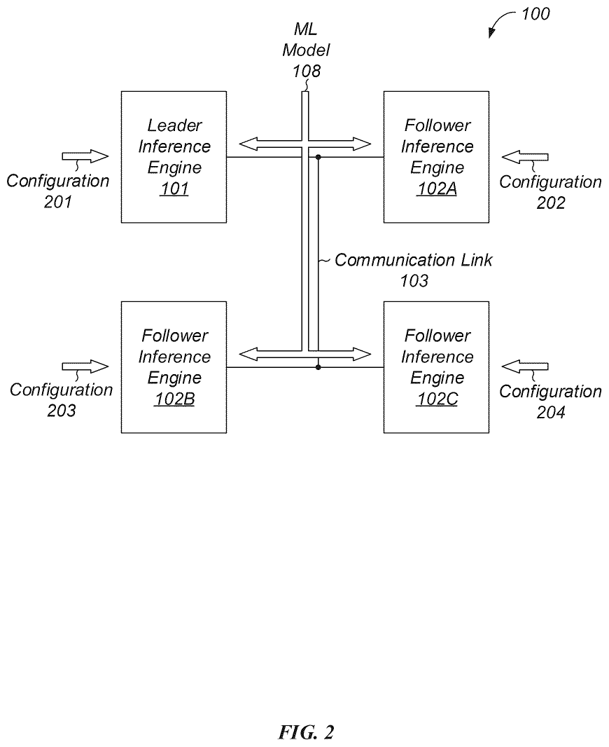

As described above, the various inference engines in distributed inference engine system 100 employ respective copies of ML model 108. In various embodiments, copies of ML model 108 are provided to the inference engines during an initialization operation that is triggered by a boot operation. A block diagram depicting initialization of a distributed inference engine system is illustrated in FIG. 2.

A boot operation may, in some embodiments, be triggered by a power-up of a server or other computer system that includes the distributed inference engine. Alternatively, or additionally, the boot operation may be triggered in response to a user-initiated reset or any other suitable user action.

In response to a detection of a boot operation, leader inference engine 101 and follower inference engines 102A-102C are configured to load respective copies of ML model 108. In various embodiments, a master copy of ML model 108 is maintained on a storage medium included on a server that includes distributed inference engine 100. In some embodiments, ML model 108 may be in a compressed format, and leader inference engine 101 and follower inference engines 102A-102C may include one or more circuits configured to perform decompression of portions of ML model 108 as the portions are selected for use.

Leader inference engine 101 and follower inference engines 102A-102C are also configured, in response to the detection of the boot operation, to assign corresponding portions of ML model 108 to leader inference engine 101 and follower inference engines 102A-102C. To assign the corresponding portions of ML model 108, each of leader inference engine 101 and follower inference engines 102A-102C are configured to receive configurations 201-204, respectively. In various embodiments, configurations 201-204 may include information indicative of which portion of ML model 108 the corresponding inference engine is to use while operating in tensor parallelism mode. It is noted that configurations 201-204 may include additional information relating to the operation of leader inference engine 101 and follower inference engines 102A-102C.

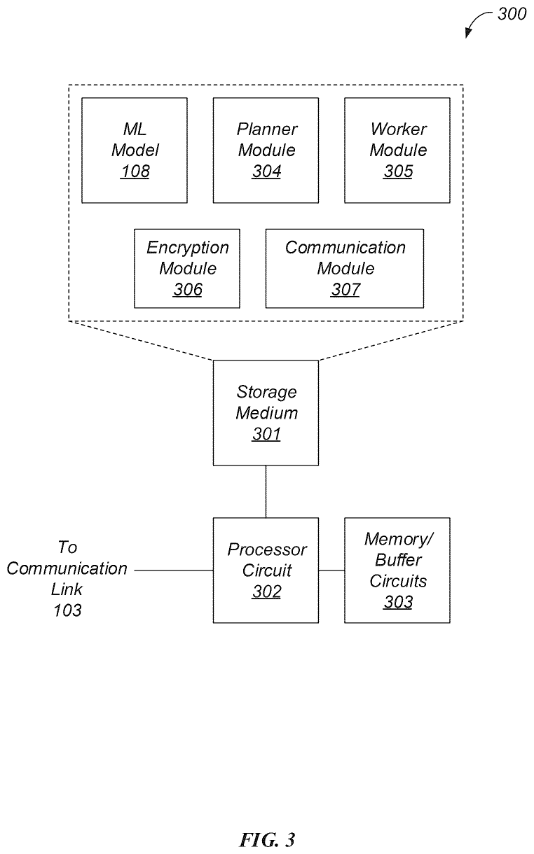

Turning to FIG. 3, a block diagram of an embodiment of a leader inference engine is depicted. As illustrated, leader inference engine 300 includes storage medium 301, processor circuit 302, and memory/buffer circuits 303. In various embodiments, leader inference engine 300 may correspond to leader inference engine 101. It is noted that the particular combination of hardware and software depicted in FIG. 3 is merely an example. In other embodiments, dedicated hardware may be employed to replace or reduce the complexity of different software modules.

Storage medium 301 is configured to store ML model 108, planner module 304, worker module 305, encryption module 306, and communication module 307. In various embodiments, different ones of the software modules stored in storage medium 301 may, during execution by processor circuit 302, interact with aspects of the operating system executing on processor circuit 302.

Planner module 304, when executed by processor circuit 302, may be responsible for dividing prompt data, e.g., data 106, between various inference engines included in a distributed inference engine system. Additionally, planner module 304 may be responsible for initiating a switch from data parallelism mode to tensor parallelism mode once an initial token has been generated by the distributed inference engine system.

Worker module 305, when executed by processor circuit 302, may cause processor circuit 302 to calculate partial results used to generate a token. Initially, worker module 305 may operate in data parallelism mode. After an initial token is generated, worker module 305 may switch to operate in tensor parallelism mode. In various embodiments, worker module 305 may be configured to exchange partial results with other inference engines at synchronization points during the processing of prompt 104.

As part of the exchange of partial results with other inference engines, encryption module 306 may cause processor circuit 302 to encrypt the partial results to generate encrypted data. Communication module 307 may cause processor circuit 302 to transfer the encrypted data to another inference engine using communication link 103, or by storing the encrypted data in a particular address location in memory/buffer circuits 303.

Storage medium 301 may be a type of non-transitory computer-readable storage medium and may include any of various appropriate types of memory devices or storage devices. Storage medium 301 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash memory, magnetic media, e.g., a hard drive, or optical storage; registers, or other similar types of memory elements, etc. Storage medium 301 may include other types of non-transitory memory as well, or combinations thereof. Accordingly, storage medium 301 may include two or more memory media, which may reside in different locations—for example, in different computer systems that are connected over a network.

Processor circuit 302 may be configured to execute any of the software instructions included in any of the modules stored in storage medium 301. In various embodiments, processor circuit 302 may include a compute complex, an input/output (I/O) bridge, a cache controller, a graphics unit, and a display unit. Processor circuit 302 may additionally include a network interface circuit that is configured to communication via various wired or wireless networks, or via communication links, such as communication link 103.

In some cases, processor circuit 302 may include an array of processing units configured to perform multiple arithmetic operations in parallel. Alternatively, processor circuit 302 may be implemented as a graphics processing unit or “GPU.”

Memory/buffer circuits 303 may be configured to store information, e.g., a portion of data 106, used by processor circuit 302. In various embodiments, one range of addresses in memory/buffer circuits 303 may be used as cache memory for processor circuit 302, and another range of addresses in memory/buffer circuits 303 may be used to store state information for leader inference engine 300. In some embodiments, different buffers may be designated as different address ranges in memory/buffer circuits 303.

In various embodiments, memory/buffer circuits 303 may be implemented using dynamic random-access memory (DRAM), synchronous DRAM (SDRAM), double data rate (DDR, DDR2, DDR3, etc.) SDRAM (including mobile versions of SDRAMs such as mDDR3, etc., and/or low power versions of SDRAMs such as LPDDR4, etc.), RAMBUS DRAM (RDRAM), static RAM (SRAM), or any other suitable type of memory circuit.

It is noted that although both memory and buffer circuits are depicted as a single block, in other embodiments, the memory circuits and the buffer circuits may be implemented separately. Moreover, one or more buffer circuits may be co-located with processor circuit 302.

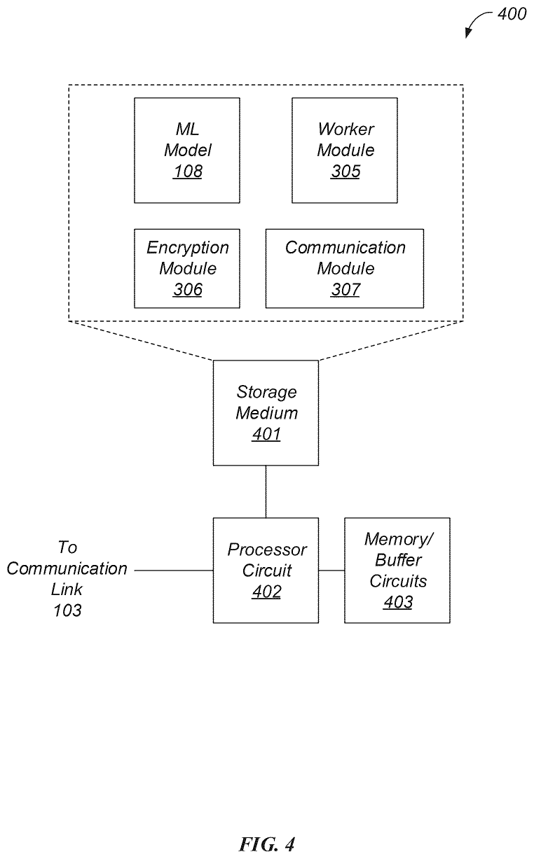

Turning to FIG. 4, a block diagram of an embodiment of a follower inference engine is depicted. As illustrated, follower inference engine 400 includes storage medium 401, processor circuit 402, and memory/buffer circuits 403. In various embodiments, follower inference engine 400 may correspond to any of follower inference engines 102A-C. It is noted that the particular combination of hardware and software depicted in FIG. 4 is merely an example. In other embodiments, dedicated hardware may be employed to replace or reduce the complexity of different software modules.

Storage medium 401 is configured to store ML model 108, worker module 305, encryption module 306, and communication module 307, all of which may function as described above in regard to FIG. 3 when executed on processor circuit 402.

Storage medium 401 may be a type of non-transitory computer-readable storage medium and may include any of various appropriate types of memory devices or storage devices. Storage medium 401 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash memory, magnetic media, e.g., a hard drive, or optical storage; registers, or other similar types of memory elements, etc. Storage medium 401 may include other types of non-transitory memory as well, or combinations thereof. Accordingly, storage medium 401 may include two or more memory media, which may reside in different locations—for example, in different computer systems that are connected over a network.

Processor circuit 402 may be configured to execute any of the software instructions included in any of the modules stored in storage medium 401. In various embodiments, processor circuit 402 may include a compute complex, an input/output (I/O) bridge, a cache controller, a graphics unit, and a display unit. Processor circuit 402 may additionally include a network interface circuit that is configured to communication via various wired or wireless networks, or via communication links, such as communication link 103.

Memory/buffer circuits 403 may be configured to store information, e.g., a portion of data 106, used by processor circuit 402. In various embodiments, one range of addresses in memory/buffer circuits 403 may be used as cache memory for processor circuit 402, and another range of addresses in memory/buffer circuits 403 may be used to store state information for leader inference engine 400. In some embodiments, different buffers may be designated as different address ranges in memory/buffer circuits 403.

In various embodiments, memory/buffer circuits 403 may be implemented using dynamic random-access memory (DRAM), synchronous DRAM (SDRAM), double data rate (DDR, DDR2, DDR3, etc.) SDRAM (including mobile versions of SDRAMs such as mDDR3, etc., and/or low power versions of SDRAMs such as LPDDR4, etc.), RAMBUS DRAM (RDRAM), static RAM (SRAM), or any other suitable type of memory circuit.

It is noted that although both memory and buffer circuits are depicted as a single block, in other embodiments, the memory circuits and the buffer circuits may be implemented separately. Moreover, one or more buffer circuits may be co-located with processor circuit 402.

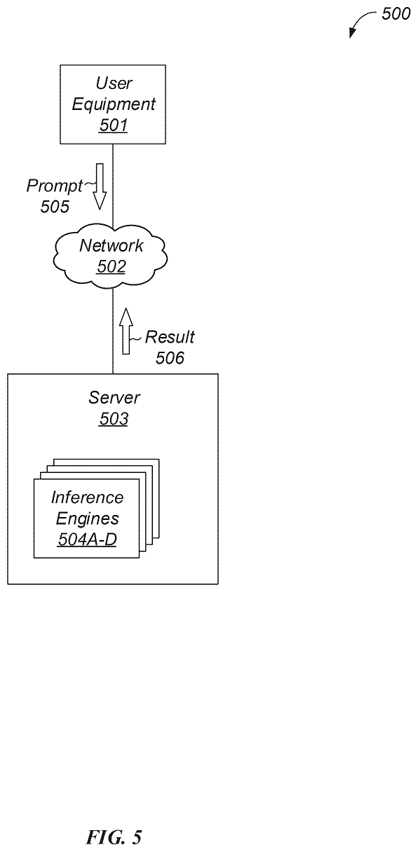

Turning to FIG. 5, a block diagram depicting an embodiment of user equipment connected to a server that includes a distributed inference engine system is illustrated. System 500 includes user equipment 501 coupled to server 503 via network 502.

User equipment 501 is configured to generate prompt 505. In some embodiments, user equipment 501 is also configured to send prompt 505 to server 503 via network 502. In various embodiments, network 502 may be either a wired, e.g., Ethernet, or wireless, e.g., WiFi, network.

In different embodiments, user equipment 501 may be implemented using a desktop computer, a laptop computer, a tablet computer, a cellular or mobile phone, a smartwatch, or any other suitable computer system. Although only a single instance of user equipment is depicted in the embodiment of FIG. 5, in other embodiments, any suitable number of pieces of user equipment may be employed to send corresponding prompts to server 503.

Server 503 includes inference engines 504A-D. In various embodiments, inference engines 504A-D may correspond to leader inference engine 101 and follow inference engines 102A-C as depicted in the embodiment of FIG. 1. As described above, inference engines 504A-D can be configured to generate result 506 upon receiving prompt 505 using a machine-learning model such as ML model 108 as depicted in FIG. 1. Inference engines 504A-D can also be configured to relay result 506 to user equipment 501 via network 502.

It is noted that server 503 may include other hardware and software (not shown) that can be used to implement other functions. For example, in some embodiments, server 503 may use such additional hardware and software to serve web-pages, or provide other cloud-based computing services.

Although only four inference engines are depicted as being included in server 503, in other embodiments, any suitable number of inference engines may be employed. In some embodiments, different groups of inference engines may be grouped together to form a different distributed inference engine system.

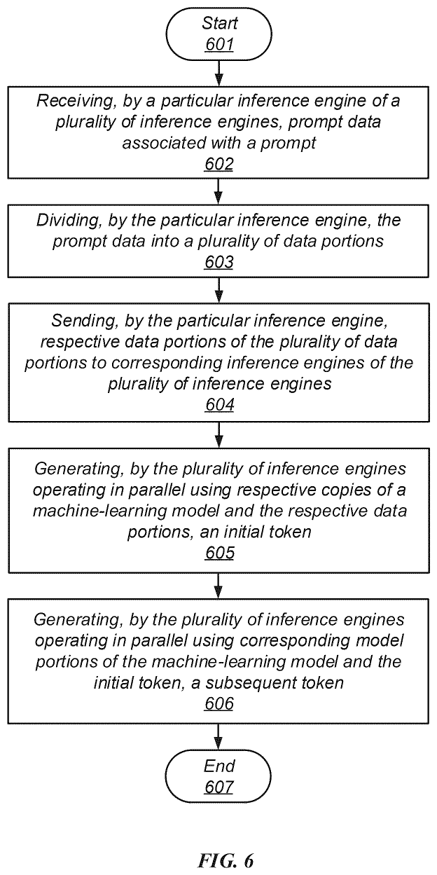

Turning to FIG. 6, a flow diagram depicting an embodiment of a method for operating a distributed inference engine system is illustrated. The method, which may be applied to various distributed inference engine systems, e.g., distributed inference engine system 100 as depicted in FIG. 1, begins in block 601.

The method includes receiving, by a particular inference engine of a plurality of inference engines, prompt data associated with a prompt (block 602). In various embodiments, the prompt may be any suitable combination of words instructing the distributed inference engine system to perform a particular task. For example, a prompt may specify a task such as “summarize this news article.” The prompt may, in some embodiments, be generated by user equipment, e.g., a smartphone, and sent to the distributed inference engine system via a wired or wireless network.

The method further includes dividing, by the particular inference engine, the prompt data into a plurality of data portions (block 603). In some embodiments, dividing the prompt data may include determining a number of data portions included in the plurality of data portions based on a size of the prompt data. For example, in order to achieve a desired latency with a large amount of prompt data, more of the available inference engines may be employed, thereby increasing the number of data portions.

Additionally, or alternatively, dividing the prompt data may include determining the number of data portions included in the plurality of data portions based on a desired power consumption and/or latency associated with processing the prompt. For example, when low latency is desired, a larger number of data portions may be generated provided there are a sufficient number of inference engines available for the respective data portions. Alternatively, when a low power consumption is desired, less inference engines may be employed, resulting in fewer data portions.

The method also includes sending, by the particular inference engine, respective data portions of the plurality of data portions to corresponding inference engines of the plurality of inference engines (block 604). In various embodiments, sending the respective data portions may include encrypting the respective data portions prior to sending. In some embodiments, sending the respective data portions may include storing the respective data portions, or their corresponding encrypted data, into corresponding buffers of a plurality of buffers.

The method further includes generating, by the plurality of inference engines operating in parallel using respective copies of a machine-learning model and the respective data portions, an initial token (block 605). In various embodiments, generating the initial token includes exchanging, by at least one inference engine of the plurality of inference engines, partial results with the remaining inference engines of the plurality of inference engines.

In some embodiments, exchanging the partial results may include encrypting, by the at least one inference engine, the partial results to generate encrypted data. The method may additionally include transmitting, by the at least one inference engine, the encrypted data to the remaining inference engines via a communication link. In various embodiments, the communication link may be a wired link while, in other embodiments, the communication link may be a wireless link.

The method also includes generating, by the plurality of inference engines operating in parallel using corresponding model portions of the machine-learning model and the initial token, a subsequent token (block 606). It is noted that the operation of block 606 may be repeated any suitable number of times in order to satisfy the prompt. For example, the operation of block 606 may be repeated using the subsequent token and the corresponding model portions of the machine-leaning model to generate another token, and so on. The method concludes in block 607.

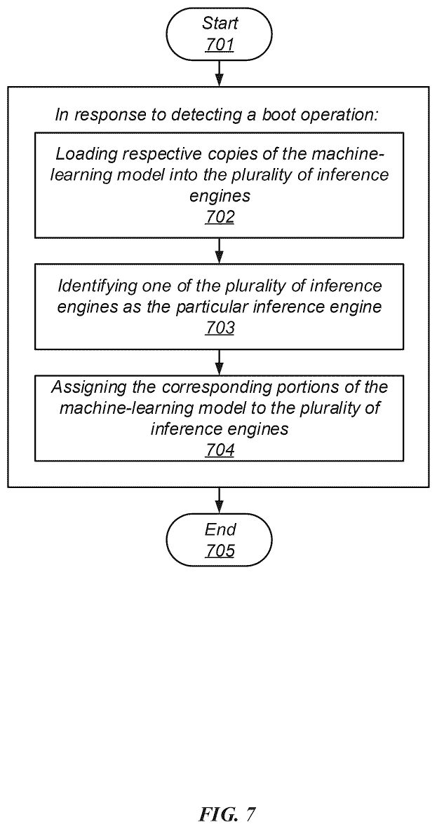

Turning to FIG. 7, a flow diagram depicting an embodiment of a method for initializing a distributed inference engine system is illustrated. The method, which may be applied to various distributed inference engine systems, e.g., distributed inference engine system 100 as depicted in FIG. 1, begins in block 701.

In various embodiments, the method depicted in the flow diagram of FIG. 7 may be used in combination with the method depicted in FIG. 6. In some embodiments, the boot operation may be in response to a power-up of a server, e.g., server 503. Alternatively, or additionally, the boot operation may be in response to a user-initiated reset or any other suitable stimulus intended to restart the distributed inference engine.

The method includes, in response to detecting a boot operation, loading respective copies of the machine-learning model into the plurality of inference engines (block 702). In various embodiments, a copy of the machine-learning model is maintained in a storage circuit coupled to the distributed inference engine system. In some embodiments, the machine-learning model is loaded into each inference engine included in the distributed inference engine system via a communication link, such as communication link 103. It is noted that, in some embodiments, the machine-learning model may be compressed to reduce an amount of storage needed in the inference engines.

The method also includes, in response to detecting the boot operation, identifying one of the plurality of inference engines as the particular inference engine (block 703). In some embodiments, processor circuits used to implement the different inference engines may be organized according to ranks. In some cases, an initial rank, e.g., rank 0, may be designated as a leader inference engine for the distributed inference engine system. As part of the identification process of the leader inference engine, additional software modules, e.g., planner module 304, may be loaded and/or activated for the leader inference engine.

The method further includes, in response to detecting the boot operation, assigning the corresponding portions of the machine-learning model to the plurality of inference engines (block 704). In various embodiments, different configurations, e.g., configurations 201-204, may be loaded into corresponding ones of the inference engines. Such configurations may, in some embodiments, specify a range of weights in the machine-learning model that the corresponding inference engines are to use once the initial token is generated. The method concludes in block 705.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third,” when applied to a feature, do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors, or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, a circuit, or a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), a functional unit, a memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as a structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits, or portions thereof, may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
a plurality of follower inference engines; and
a leader inference engine configured to:
receive a prompt that includes prompt data;
divide the prompt data into a plurality of data portions; and
send respective data portions to the plurality of follower inference engines; and
wherein the plurality of follower inference engines and the leader inference engine are configured to:
generate, in parallel using respective copies of a machine-learning model and the respective data portions, an initial token; and
generate, in parallel using corresponding model portions of the machine-learning model and the initial token, a subsequent token.

2. The apparatus of claim 1, wherein the plurality of follower inference engines and the leader inference engine are further configured, in response to a detection of a boot operation, to:
load respective copies of the machine-learning model; and
assign the corresponding portions of the machine-learning model to the leader inference engine and the plurality of follower inference engines.

3. The apparatus of claim 1, wherein to generate the initial token, a particular follower inference engine of the plurality of follower inference engines is further configured to exchange partial results with a different follower inference engine of the plurality of follower inference engines.

4. The apparatus of claim 3, wherein to exchange the partial results, the particular follower inference engine is further configured to:
encrypt the partial results to generate encrypted data; and
transmit the encrypted data to the different follower inference engine.

5. The apparatus of claim 1, wherein to divide the prompt data, the leader inference engine is further configured to determine a number of data portions included in the plurality of data portions based on a size of the prompt data.

6. The apparatus of claim 1, wherein to divide the prompt data, the leader inference engine is further configured to determine a number of data portions included in the plurality of data portions based on a desired power consumption for processing the prompt.

7. A method, comprising:
receiving, by a particular inference engine of a plurality of inference engines, prompt data associated with a prompt;
dividing, by the particular inference engine, the prompt data into a plurality of data portions;
sending, by the particular inference engine, respective data portions of the plurality of data portions to corresponding inference engines of the plurality of inference engines;
generating, by the plurality of inference engines operating in parallel using respective copies of a machine-learning model and the respective data portions, an initial token; and
generating, by the plurality of inference engines operating in parallel using corresponding model portions of the machine-learning model and the initial token, a subsequent token.

8. The method of claim 7, further comprising, in response to detecting a boot operation:
loading respective copies of the machine-learning model into the plurality of inference engines;
identifying one of the plurality of inference engines as the particular inference engine; and
assigning the corresponding portions of the machine-learning model to the plurality of inference engines.

9. The method of claim 7, wherein generating the initial token includes exchanging, by at least one inference engine of the plurality of inference engines, partial results with remaining inference engines of the plurality of inference engines.

10. The method of claim 9, wherein exchanging the partial results includes:
encrypting, by the at least one inference engine, the partial results to generate encrypted data; and
transmitting, by the at least one inference engine, the encrypted data to the remaining inference engines via a communication link.

11. The method of claim 7, wherein dividing the prompt data into the plurality of data portions includes determining a number of data portions included in the plurality of data portions based on a size of the prompt data.

12. The method of claim 7, wherein dividing the prompt data into the plurality of data portions includes determining a number of data portions included in the plurality of data portions based on a desired power consumption for processing the prompt.

13. The method of claim 7, wherein sending the respective data portions includes storing the respective data portions into corresponding buffers of a plurality of buffers.

14. A tangible non-transitory computer-readable storage medium having program instructions stored therein that, in response to execution by a computer system, causes the computer system to perform operations including:
receiving, by a particular inference engine of a plurality of inference engines, prompt data associated with a prompt;
dividing, by the particular inference engine, the prompt data into a plurality of data portions;
sending, by the particular inference engine, respective data portions of the plurality of data portions to corresponding inference engines of the plurality of inference engines;
generating, by the plurality of inference engines operating in parallel using respective copies of a machine-learning model and the respective data portions, an initial token; and
generating, by the plurality of inference engines operating in parallel using corresponding model portions of the machine-learning model and the initial token, a subsequent token.

15. The tangible non-transitory computer-readable storage medium of claim 14, wherein the operations further include, in response to detecting a boot operation:
loading respective copies of the machine-learning model into the plurality of inference engines;
identifying one of the plurality of inference engines as the particular inference engine; and
assigning the corresponding portions of the machine-learning model to the plurality of inference engines.

16. The tangible non-transitory computer-readable storage medium of claim 14, wherein generating the initial token includes exchanging, by at least one inference engine of the plurality of inference engines, partial results with remaining inference engines of the plurality of inference engines.

17. The tangible non-transitory computer-readable storage medium of claim 16, wherein exchanging the partial results includes:
encrypting, by the at least one inference engine, the partial results to generate encrypted data; and
transmitting, by the at least one inference engine, the encrypted data to the remaining inference engines via a communication link.

18. The tangible non-transitory computer-readable storage medium of claim 14, wherein dividing the prompt data into the plurality of data portions includes determining a number of data portions included in the plurality of data portions based on a size of the prompt data.

19. The tangible non-transitory computer-readable storage medium of claim 14, wherein dividing the prompt data into the plurality of data portions includes determining a number of data portions included in the plurality of data portions based on a desired power consumption for processing the prompt.

20. The tangible non-transitory computer-readable storage medium of claim 14, wherein sending the respective data portions includes storing the respective data portions into corresponding buffers of a plurality of buffers.
